(19) United States
(12) Patent Application Publication
(10) Pub. No.: US 2005/0195729 A1
(43) Pub. Date: Sep. 8, 2005

(54) Optical recording medium, method and apparatus for optical recording and reproducing using the same

(76) Inventors: Hiroshi Miura, Yokohama-shi (JP); Makoto Harigaya, Hiratsuka-shi (JP); Eiko Hibino, Yokohama-shi (JP); Kazunori Ito, Yokohama-shi (JP)

Correspondence Address: COOPER & DUNHAM, LLP, 1185 AVENUE OF THE AMERICAS, NEW YORK, NY, 10036, US

(21) Appl. No.: 11/067,856

(22) Filed: Feb. 28, 2005

(30) Foreign Application Priority Data
Mar. 2, 2004 (JP) 2004-058280

(51) Int. Cl. G11B 7/24

(52) U.S. Cl. 369/275.2; 369/288

(57) ABSTRACT

The object of the present invention is to provide an optical recording medium which can respond to high-density and high recording linear velocity with recording linear velocity at 1.0× to 16× or more (recording linear velocity=approx. 3.5 m/s to 56 m/s or more), and a method and an apparatus for the optical recording and reproducing. Thus, the present invention provides an optical recording medium comprising a substrate and at least a recording layer and a reflective layer disposed on the substrate, in which any one of recording, reproducing, erasing, and rewriting of information is enabled by irradiating laser beam to the recording layer to induce a reversible phase change on the recording layer in which the reflectance (Rg) of the non-recorded portion in the case of the recording layer comprising Zn, Sn, and Sb and the laser beam wavelength being within the range of 650 nm to 665 nm is 12% to 30%.

### BACKGROUND OF THE INVENTION

1. Field of the Invention

The present invention relates to an optical recording medium allowing high-density recording as much capacity as DVD-ROM (Digital Versatile Disc-Read Only Memory) or more and also capable of covering a recording linear velocity as fast as 16× or more (recording linear velocity=approx. 56 m/s or more) (hereinafter, it may be referred to as “phase-change optical information recording medium”, “phase-change optical recording medium”, or “optical information recording medium”) and also relates to a method for recording and reproducing using the optical recording medium, and an optical recording and reproducing apparatus.

2. Description of the Related Art

DVD+RW (Digital Versatile Disc-Rewritable) is a sort of phase-change optical recording media, which has high degree of compatibility with DVD+ROM and allows repeatable recording, has been standardized by “DVD+ROM 4.7 Gbytes Basic Format Specifications System Description” and has been put into practical use as a recording medium for high-volume moving pictures and an external storage medium for personal computers.

For the above-mentioned phase-change optical recording medium, recording and erasing are performed through heating of a recording layer by irradiating laser beam to the recording layer disposed on a substrate, and utilizing altered disc reflectance to induce a phase change between an amorphous phase and a crystalline phase on the material of the recording layer.

Concerning the material of DVD recording layers, a medium capable of a higher speed of recording and reproducing is required because of high volume data being handled therein, and a system capable of recording at a speed of 2.5× (recording linear velocity=approx. 8.5 m/s) have been placed on the market, but there have been increasing demands on higher-speed recording.

The recording material currently used for DVD+RW, which AgInSbTe material used for CD is improved to allow recording and erasing over a high linear velocity region (recording linear velocity=approx. 8.5 m/s) (Japanese Patent Application Laid-Open (JP-A) No. 2000-322740).

This material of Ag InSbTe has more Sb content than the recording material for CD-RW in order to respond to recording speeds at the high linear velocity region, but this has a problem that a material having a high volume of Sb composition ratio lowers the crystallization temperature, although accelerating the crystallization speed. A decrease in crystallization temperature leads to degradation of storage reliability, and thus the problem with disc storage reliability is suppressed to the extent where no problem occurs in practical use by increasing the volume of Ag in the recording material or adding a quintessence such as Ge.

However, if the volume of Sb is further increased for achieving faster high linear velocity, the recording layer will be ultimately divided into a Sb phase and other phases thereof, and there is a problem that the recording layer will not serve as a phase-change layer. The speed limit for recording in this particular case is around 20 m/s in DVD recording density.

On the other hand, a recording material of ternary alloy comprising Zn, Sn, and Sb has been proposed in Japanese Patent (JP-B) No. 2713989. This ternary alloy recording material comprising Zn, Sn, and Sb provides a remarkably high crystallization speed and a possibility of realizing high linear velocity recording.

The recording material described in JP-B No. 2713989 is, however, proposed as a recording element for just a single writing and is not disclosed as a phase-change recording layer. The recording material of ternary alloy comprising Zn, Sn and Sb is amorphous when formed through the use of a film-forming medium such as a sputtering method, but if once crystallized by a heating medium such as laser beam irradiation, it is very difficult to transform the crystallized material to amorphous by using a recording pulse comprising the train of laser pulses or the like. Because of this, there is a problem that it is not easy to make this material serve as a recording layer, namely, it is difficult to induce a reversible phase change between an amorphous phase and a crystalline phase on a recording layer by irradiating an electromagnetic wave to perform at least any one of writing, reproducing, erasing, or rewriting by utilizing an optical variation.

Hence, an optical recording medium capable of achieving high density recording and high-speed recording linear velocity as fast as 1.0× to 16× or more (this recording linear velocity=approx. 3.5 m/s to approx. 56 m/s or more) and having completely satisfactory performance has not yet been provided, and further improvements and developments are desired under the current situation.

### SUMMARY OF THE INVENTION

It is therefore an object of the present invention to provide an optical recording medium capable of responding to high density recording and high-speed recording linear velocity as fast as 1.0× to 16× or more (recording linear velocity=approx. 3.5 m/s to 56 m/s or more), and a method for recording and reproducing using the optical recording medium, and an optical recording and reproducing apparatus.

As a result of repeated keen examinations by the inventors of the present invention for resolving the problems stated above, with respect to an optical recording medium allowing high density recording as much as that of DVD-ROM or more and further capable of achieving recording linear velocity as fast as 16× or more (this recording linear velocity=approx. 56 m/s or more), it is found that if the condition that the reflectance (Rg) of a not-recoded portion in a disc in the case of the wavelength of laser beam being 650 nm to 665 nm, using a DVD recording system having a lens numerical aperture (NA)=0.65, is 12% to 30% is satisfied, then it is possible to induce a reversible phase change between an amorphous phase and a crystalline phase on the recording layer by irradiating laser pulses to effectively perform at least any one of recording, reproducing, erasing, and rewriting by utilizing optical variations. This finding led to the present invention.

The optical recording medium according to the present invention comprises a substrate and at least a recording layer and a reflective layer disposed on the substrate, and in which any one of recording, reproducing, erasing, and rewriting of information can be performed by inducing a reversible phase change on the recording layer by irradiating laser beam to the recording layer, and the reflectance (Rg) of non-recorded portion of the recording layer in the case of the recording layer comprising Zn, Sn and Sb and the wavelength of the laser beam being within the range of 650 nm to 665 nm is 12% to 30%. The optical recording medium according to the present invention enables transformations-to-amorphous, even if a material having difficulties in transforming to an amorphous substance like an alloyed metal comprising Zn, Sn, and Sb is used, by reducing the reflectance to increase the light energy absorptivity within a disc and to raise the solution temperature to improve the cooling rate. This medium also enables high-density recording capacity as much as that of DVD-ROM or more and further covers recording linear velocity as fast as 16× or more (this recording linear velocity=approx. 56 m/s or more).

The method for recording and reproducing using the optical recording medium according to the present invention enables performing at least any one of recording and reproducing information by irradiating laser beam from the first protective layer side to a recording layer of the optical recording medium of the present invention.

According to the method of the present invention, at least any one of recording and reproducing of information is performed by irradiating laser beam to the optical recording medium of the present invention. As a result, any of recording and reproducing of information can be effectively performed in stable and assured condition.

In accordance with the apparatus for optical recording and reproducing of the present invention, at least any one of recording and reproducing of information is performed in the optical recording medium by irradiating laser beam to the optical recording medium from the laser beam source, and the optical recording medium according to the present invention is used as an optical recording medium.

In the apparatus of the present invention which performs at least any one of recording and reproducing information in the optical recording medium by irradiating laser beam to the optical recording medium from the laser beam source, the optical recording medium according to the present invention is used as the above-mentioned phase-change optical recording medium. The apparatus enables performing at least any one of steady and reliable recording and reproducing of information.

### BREIF DESCRIPTION OF THE DRAWING

FIGURE 1 is a cross-sectional schematic view showing an example of the laminar structure of the optical recording medium according to the present invention.

### DESCRIPTION OF THE PREFERRED EMBODIMENTS

(Optical Recording Medium)

An optical recording medium according to the present invention comprises a substrate and at least a first protective layer, a recording layer, a second protective layer, and a reflective layer disposed on the substrate in one of this sequence and the opposite sequence, and further comprising other layers when required.

In this case, the optical recording medium performs at least any one of recording, reproducing, erasing, and rewriting of information by irradiating leaser beam from the first protective layer side.

In the present invention, the recording layer in the phase-change optical recording medium may comprise Zn, Sn, and Sb, and the reflectance (Rg) of a non-recorded portion in the recording layer, in the case of the wavelength of the laser beam being within the range of 650 nm to 665 nm, is within the range of 12% to 30%, and preferably within the range of 18% to 25%.

Here, the reflectance of non-recorded portion in the recording layer is a key property, which determines the recording properties of a disc, since the reflectance changes the light energy absorptivity within an optical recording medium (disc). A transformation-to-amorphous in a phase-change recording material is realized by the processes in which light energy absorbed on the recording layer is accumulated thereon, and the recording layer is dissolved and then be quenched. Therefore, it becomes possible to obtain a transformation-to-amorphous, even if a material having difficulties in transforming to amorphous, like an alloyed metal comprising Zn, Sn, and Sb, by reducing the reflectance to increase the light energy absorptivity within a disc and to raise the solution temperature then to improve the cooling rate. However, if the reflectance is reduced to an extreme degree, this time it leads to a problem that sufficient signal strength cannot be obtained in the recording system.

Thus, the reflectance (Rg) of non-recorded portion in the recording layer is preferably within the range of 12%≦Rg≦30%. If the reflectance is less than 12%, sufficient signal strength may not be obtained in the recording system, and if more than 30%, sufficient degree of modulation, namely, a sufficient transformation-to-amorphous may not be realized due to the lack of recording energy.

It should be noted in the present invention that the non-recorded portion in the recording layer indicates the portion not recorded in the groove (guide groove) thereof.

Here, the reflectance can be measured by using, for instance, an optical disc evaluation apparatus (DDU-1000, manufactured by Pulstec Industrial Co., Ltd.).

In the present invention, the degree of modulation (M) between the reflectance of a record mark (Rb) and the reflectance of non-recorded portion in the recording layer (Rg), (M=(Rg−Rb)/Rg), is 0.4 or more, when the wavelength of laser beam is within the range of 650 nm to 665 nm, the lens numerical aperture (NA) of the optical system is 0.65, and the range of recording linear velocity (V) is 3.5 m/s≦V≦57 m/s. Here, if the degree of modulation (M) is 0.4 or more, this can be judged as recordable, and if less than 0.4, this can be judged as non-recordable.

Also, when the thickness of the first protective layer is t₁ (nm), the thickness of the recording layer is t₂ (nm), the thickness of the second protective layer is t₃ (nm), the thickness of the reflective layer is t₄ (nm), and the wavelength of the laser beam is λ (nm), it is preferable to satisfy the relations expressed by:
0.070≦t₁/≦0.16, 0.015≦t₂/λ≦0.032, 0.009≦t₃/λ≦0.040, and 0.10≦t₄/λ.

To satisfy the conditions mentioned above, for instance, the thicknesses of the second protective layer and reflective layer may be set so that these thickness conditions stated above are satisfied so as to primarily control the thicknesses of the recording layer and the first protective layer. Especially when the wavelength of the laser beam is determined, it is easy to set the thicknesses of the recording layer and the protective layer because the thicknesses thereof can be respectively chosen from the limited ranges. For instance, when the reflectance is requested to be increased within the range of reflectance (Rg) stated above, this can be resolved by setting the thicknesses of the recording layer and the first protective layer thicker. When the thickness of the recording layer dropped off from the determined thickness condition is set, however, controlling of the reflectance by the first protective layer becomes difficult with the Rg range, so the thickness of the recording layer is preferably within the range of 0.015≦t₂/λ≦0.032.

Here, if the thickness of the recording layer is set within the range of 0.015≦t₂/λ≦0.032, besides the first thickness range of 0.070≦t₁/λ≦0.16, there will be the second and third thickness ranges which are both thicker than the first thickness range of 0.070≦t₁/λ≦0.16. However, it is advantageous to use the first thickness range to realize low-cost discs from the viewpoint of manufacturing optical discs, because the second and the third thickness ranges are both thicker than the first thickness range, which makes manufacturing time per optical disc longer. Thus, it is preferable that the thickness of the first protective layer satisfies the relation expressed by 0.070≦t₁/λ≦0.16 when the wavelength of the laser beam is regarded as λ.

The second protective layer serves to make heat generated by thermal relaxation of light energy absorbed within the disc (the main body of the absorption is the material of recording layer) once accumulated as well as propagated to the reflective layer and then make heat dissipated. Therefore, it is preferable that the second protective layer is not too much thick, and preferably within the range of 0.009≦t₃/λ≦0.40. If the thickness of the second protective layer is thicker than the above mentioned, a recording mark blurs due to gathered heat in the recording layer, and recording properties, particularly jitter property becomes worse. The jitter property is evaluated by a variation of a mark edge expressed based on a channel cycle (Tw), σ/Tw. On the other hand, if the thickness of the second protective layer is thinner than this, this causes a problem that satisfactory recording properties cannot be obtained, because the absorbed light energy heat dissipates before being an amount of heat capable of achieving the principle of phase-change recording, which light energy absorbed in a recording layer is accumulated to dissolve the recording layer, thereby a record mark is made.

It is noted that the power density of laser beam varies depending on the wavelength used in the recording system, so there will be a need to change the thickness of the above-mentioned second protective layer. This can be resolved by setting the thickness of the second protective layer within the range satisfying the above-mentioned optical thickness condition. This also applies to the thickness conditions for other layers mentioned above.

Next, the structure of the optical recording medium according to the present invention will be described in detail based on the accompanying drawing.

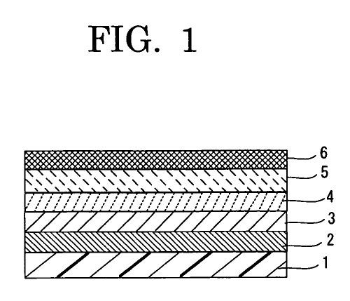

Here, FIG. 1 is a cross-sectional schematic view showing an example of the optical recording medium according to the present invention, in which a first protective layer 2, a recording layer 3, a second protective layer 4, a third protective layer 5, and a reflective layer 6 are laminated on a substrate 1 in the order named described above.

Recording Layer

The recording layer 3 contains Zn, Sn, and Sb, and when the necessity arises for the purpose of improving stability of an amorphous substance or the like and further contains at least one element selected from Mg, Al, Si, Ca, Cr, Mn, Co, Cu, Ga, Ge, Se, Te, Pd, Ag, and rare-earth elements, as other elements except the above-mentioned three elements. As rare-earth elements, for example, Sc, Y, La, Ce, Pr, Nd, Pm, Sm, Eu, Gd, Tb, Dy, Ho, Er, Tm, Yb, Lu and the like can be listed.

The addition amount of other elements mentioned above is preferably 15 atomic percent or less, and more preferably in the range of 0 atomic percent to 10 atomic percent. If the addition amount is more than 15 atomic percent, there may be cases where the crystallization rate becomes slower, although the stability of the amorphous substance can be enhanced.

Specifically, the composition of the recording layer is expressed by Zn_{α}Sn_{β}Sb_{γ}—X_{ε} (α, β, γ, and ε respectively represent an atomic ratio. X represents at least one element selected from Mg, Al, Si, Ca, Cr, Mn, Co, Cu, Ga, Ge, Se, Te, Pd, Ag, and rare-earth elements), and the composition ratio is expressed as follows:
0.03≦α≦0.3, 0.1≦β≦0.9, 0.1≦γ≦0.9, 0≦ε≦0.15, and α+β+γ+ε=1

It is preferable that the composition ratio of the recording layer is as follows:
0.05≦α≦0.2, 0.1≦β≦0.6, 0.3≦γ≦0.8, 0≦ε≦0.1, and α+β+γ+ε=1
When the composition ratio of the recording layer satisfies the defined condition above, a disc having an adequate jitter property and degree of modulation can be obtained, even if overwritten repeatedly. The temperature of crystallization on the recording layer with a temperature rising rate at 10° C./min. is preferably within the range of 150° C. to 250° C., and more preferably within the range of 160° C. to 220° C. In this range of crystallization temperature, the stability of amorphous substance can be assured.

The thickness of the recording layer (t₂) is preferably within the range of 5 nm to 20 nm, and as described above, it is preferred that the formula, 0.015≦t₂/λ≦0.032, is satisfied, when the wavelength of laser beam is regarded as λ.

For a method for forming the recording layer, various vapor growth methods, for example, a vacuum evaporation method, a sputtering method, a plasma CVD method, an optical CVD method, an ion plating method, an electron-beam deposition method and the like, are used. Among these methods, a sputtering method excels in mass productivity, quality of layers and the like.

In a sputtering method, argon (Ar) gas is used as film-forming gas, and a sputtering target comprising Zn, Sn, and Sb is used, and the composition of this sputtering target is expressed by Zn_{α}Sn_{β}Sb_{γ}—X_{ε} (however, α, γ, γ, and ε respectively represent its atomic ratio. X represents at least one element selected from Mg, Al, Si, Ca, Cr, Mn, Co, Cu, Ga, Ge, Se, Te, Pd, Ag, and rare-earth elements), and it is preferably as follows:
0.03≦α≦0.3, 0.1≦β≦0.9, 0.1≦γ≦0.9, 0≦ε≦0.15, and α+β+γ+ε=1

It is more preferable that the composition ratio of the recording layer is expressed as follows:
0.05≦α≦0.2, 0.1≦β0.6, 0.3≦γ≦0.8, 0≦ε0.1, and α+β+γ+ε=1
First Protective Layer and Second Protective Layer

The first protective layer 2 and the second protective layer 4 have effects of preventing deterioration/degeneration change in quality of the recording layer, improving adhesive strength of the recording layer 3 as well as improving its recording properties an the like. For example, metal oxides such as SiO, SiO₂, ZnO, SnO₂, Al₂O₃, TiO₂, In₂O₃, MgO, ZrO₂; nitride such as Si₃N₄, AlN, TiN, BN, ZrN; sulfide such as ZnS, In₂S₃, TaS₄; carbide such as SiC, TaC, B₄C, WC, TiC, ZrC; carbon in the form of diamond, or mixtures thereof can be listed. Among the mentioned above, a mixture of ZnS and SiO₂ is particularly preferable. The mixture of ZnS and SiO₂ is the most preferable in that the mixture excels in heat resistance, low-thermal conductivity and chemical stability and is having lower residual stress in its film, and it is unlikely that deterioration in properties such as recording sensitivity and erasing ratio will occur, even if repeatedly recorded and erased. The mixture has also excellent adhesion to the recording layers.

Examples of the method for forming the first protective layer 2 and the second protective layer 4 include a vacuum evaporation method, a sputtering method, a plasma CVD method, an optical CVD method, an ion plating method, an electron-beam deposition method. Among these methods, a sputtering method excels in mass productivity, quality of layers, and the like.

There is no particular limitation on the thicknesses of the first protective layer 2 and the second protective layer 4. These two protective layers can be chosen as required in accordance with the purpose. The thickness of the first protective layer (t₁) is preferably in the range of 50 nm to 90 nm, and as described above, it is preferred that the formula, 0.070≦t₁/λ≦0.16 is satisfied, when the wavelength of laser beam is regarded as λ.

Also, the thickness of the second protective layer (t₃) is preferably in the range of 6 nm to 20 nm, and as described above, it is preferred that the formula, 0.009≦t₃/λ≦0.040 is satisfied, when the wavelength of laser beam is regarded as λ.

Reflective Layer

The reflective layer serves as an optical reflection layer, while also serving as a heat dissipation layer for dissipating heat added in the recording layer by irradiating laser beam at the time of recording. Choosing a reflective layer material is quite important in a medium capable of responding to high linear velocity, because forming of an amorphous mark is heavily affected by cooling rate through heat dissipation.

For the reflective layer 6, a metallic material, for example, Al, Au, Ag, Cu, Ta and the like can be used. Further, as an element to be added to these metallic materials, Cr, Ti, Si, Cu, Ag, Pd, Ta or the like can be used. Among these materials, it is preferred that any one of Ag and an Ag metal alloy is contained therein. This is because a high thermal conductivity and high reflectance metal are usually desirable for the reflective layer constituting the optical recording medium in terms of thermal conductivity for modulating cooling rate against heat generated at the time of recording and in terms of an optical viewpoint of improving the contrast of reproduction signals by utilizing interference effect, and pure Ag or an Ag metal alloy respectively has extremely high thermal conductivity, 427 W/m×K, and a quenching configuration suitable for forming an amorphous mark can be realized immediately after the recording layer reached a high temperature at the time of recording. Pure silver is the most suitable in consideration of its high thermal conductivity, but Cu may be added in consideration of corrosion resistance.

In this case, in order not to impair the property of Ag, the range of the Cu addition amount is preferably from about 0.1 atomic percent to about 10 atomic percent, and more preferably within the range of 0.5 atomic percent to 3 atomic percent. An excessive addition of Cu amount conversely will make Ag corrosion resistance deteriorated.

The reflective layer 6 can be formed by, for example, a vacuum evaporation method, a sputtering method, a plasma CVD method, an optical CVD method, an ion plating method, an electron-beam deposition method and the like. Among the above mentioned, a sputtering method excels in mass productivity, quality of layers, and the like.

The heat dissipation ability of the reflective layer is basically proportional to the thickness of the layer; however, excellent disc properties are available, if the thickness of the reflective layer is 60 nm or more. In this case, there is no particular maximum limit value thereof, and a thickness within an allowable range from disc manufacturing cost perspective may be used, however, about 300 nm or less is preferable. It is preferable that the thickness of the reflective layer (t₄), as described above, satisfies the formula, 0.10≦t₄/λ, when the wavelength of laser beam is regarded as λ.

It is noted that a resin protective layer can be provided on the reflective layer where necessary. This resin protective layer has effect for protecting a recording layer in the process flow and when manufactured as a product and is usually formed through the use of an ultraviolet-curing resin. The thickness of the resin protective layer is preferably within the range of 2 μm to 5 μm.

Third Protective Layer

It is preferred that the third protective layer 5 with no sulfur contained therein is provided between the protective layer 4 and the reflective layer 6 as a barrier layer.

As a material for the third protective layer 5, for example, Si, SiC, SiN, GeN, ZrO₂ and the like are named. Among the above-mentioned, Si or SiC is particularly preferable in the light of those high-barrier properties.

If a protective layer comprising sulfur such as a mixture of ZnS and SiO₂ is used, and when pure Ag or an Ag alloy is used for a reflective layer, sulfur will diffuse toward Ag, which will cause a problem with a disc defect (Ag reaction to sulfur). Thus, as a third protective layer for preventing such a reaction, it is desirable to select a proper material from the following perspective:
(1) preventing Ag from reacting to sulfur and having barrier properties; (2) being optically transparent to laser beam; (3) having low-thermal conductivity for forming an amorphous mark; (4) having good adhesion to protective layers and reflective layers; and (5) being easy to form. A material mainly made of Si or SiC that satisfies the above conditions is suitable for the constituent material for the third protective layer.

The thickness of the third protective layer is preferably within the range of 2 nm to 20 nm, and more preferably in the range of 2 nm to 10 nm. If the thickness is less than 2 nm, there may be cases where the third protective layer will not serve as a barrier layer, and if the thickness is more than 20 nm, this possibly results in a decrease in the modulation degree.

Substrate

Examples of the material used for the substrate 1 include a glass, a ceramics, a resin, but a substrate made from a resin is preferable in terms of formability and cost. Examples of the resin include a polycarbonate resin, an acryl resin, an epoxy resin, a polystyrene resin, an acrylonitrile-styrene copolymer, a polyethylene resin, a polypropylene resin, a silicone resin, a fluorine-contained resin, an ABS resin, an urethane. A polycarbonate resin and an acryl resin are preferable in terms of formability and optical properties, and cost.

There is no particular limitation on the thickness of the substrate 1, and the thickness is usually determined by the wavelength of the laser used and focusing property of the pickup lens used. The substrate having a thickness of 1.2 mm is used for CD with the wavelength of 780 nm, and a substrate having a thickness of 0.6 mm is used for DVD with the wavelength from 650 nm to 665 nm.

A adhesive layer for laminating the substrate 1 in which informational signals are written with a substrate for adhesion is formed by a two-sided adhesive sheet which pressure-sensitive adhesive is applied to both sides of a base film, a heat-curing resin or an ultraviolet-curing resin. The thickness of the adhesive layer is usually about 50 μm.

The substrate for adhesion (dummy substrate) does not have to be transparent when an adhesive sheet or a heat-curing resin is used for the adhesive layer, however, if an ultraviolet-curing resin is used for an adhesive layer, a transparent substrate capable of transmitting ultraviolet rays is used. It is ordinarily preferable that the substrate for adhesion has a thickness of 0.6 mm, which is the same as that of the substrate 1 in which information signals are written.

The optical recording medium according to the present invention has been described in detail; however, it is to be understood that the present invention is not limited to the disclosed aspects. On the contrary, the present invention is intended to cover various modifications and equivalent arrangements without departing from the scope of the present invention. For example, the present invention can be applied to a multiplayer phase-change optical recording medium in which same or different types of two phase-change optical recording media are bonded through a resin protective layer in place of a substrate for adhesion as can be seen in DVD.

(Method for Optical Recording and Reproducing)

In the method for recording and reproducing using the optical recording medium according to the present invention, recording and reproducing of information is performed by irradiating laser beam from the first protective layer side to individual recording layers in the optical recording medium according to the present invention.

Specifically, laser beam for recording such as semiconductor laser (for example, oscillation wavelength having a wavelength range of 350 nm to 700 nm) is irradiated from the first protective layer through an objective lens with continuously rotating the optical recording medium at a predetermined linear velocity or at a predetermined constant angular velocity. By this irradiation of laser beam, the recording layer absorbs laser beam to increase the temperature locally, for instance, then to form an amorphous mark to make information recorded thereon. Reproduction of information recorded as above can be performed by irradiating laser beam from the first protective layer side with continuously rotating the optical recording medium at a predetermined linear velocity and by detecting the reflected beam.

(Apparatus for Optical Recording and Reproducing)

The apparatus for optical recording and reproducing according to the present invention performs at least any one of recording and reproducing information in an optical recording medium by irradiating laser beam from laser beam source to the optical recording medium, and is intended to use the optical recording medium according to the present invention as an optical recording medium.

There is no particular limitation on the optical recording and reproducing apparatus, and the apparatus can be selected as needed in accordance with the intended use, however, for example, which may comprise laser beam source such as a semiconductor laser which emits laser beam; a focusing lens for concentrating laser beam emitted from the laser beam source on the optical recording medium mounted on a spindle; optical elements for guiding laser beam emitted from the laser beam source to both the focusing lens and a laser beam detector; and the laser beam detector for detecting the reflected light of the laser beam, and may further comprise other media where necessary.

The above-mentioned apparatus for recording and reproducing guides laser beam emitted from the laser beam source to the focusing lens through optical elements to perform recording in an optical recording medium by concentrating and irradiating the laser beam through the focusing lens. Here, the apparatus guides the reflected beam of the laser beam to the laser beam detector to control the amount of beam of the laser beam source based on the amount of laser beam detected by the laser beam detector.

The laser beam detector converts the detected amount of laser beam into power voltage or power current and outputs them as a signal of the detected amount.

Examples of the above-noted other media include a controlling medium. There is no particular limitation on the controlling medium, in so far as the movements of the individual media can be controlled, and it is possible to select a controlling medium in accordance with the intended use. Examples of the controlling medium include a sequencer for irradiating and scanning intensely modulated laser beam; and equipment such as computer devices.

Hereafter, the method of the present invention will be described referring to specific examples; however, the present invention includes, but not limited to the following examples.

### EXAMPLE 1

Preparation of an Optical Recording Medium

A disc substrate made from a polycarbonate resin having a diameter of 12 cm, a thickness of 0.6 mm, and a groove track pitch of 0.74 μm was subjected to dehydration at high temperature. Subsequently, respective layers of the first protective layer, the recording layer, the second protective layer, the third protective layer, and the reflective layer were formed in this sequential order by sputtering to make an optical recording medium.

First, the first protective layer was formed on the substrate using a mixture of ZnS and SiO₂ target through the use of a sputtering apparatus (Big Sprinter, made by Unaxis, Incorporated) so that the first protective layer has a thickness of 65 nm. An alloy target having the composition ratio (atomic percent ratio) of Zn_{0.11}Sn_{0.15}Sb_{0.74} was sputtered on the first protective layer under the conditions of argon gas pressure being 3×10⁻³ torr and RF power being 300 mW to form a recording layer having a thickness of 16 nm. Likewise the first protective layer, a second protective layer was formed on the recording layer using a mixture of ZnS and SiO₂ target so that the thickness of the second protective layer becomes 10 nm. A SiC target was used on the second protective layer to form a third protective layer so that the thickness thereof becomes 4 nm. A pure-silver target was used on the third protective layer to form a reflective layer so that the thickness thereof becomes 120 nm. And then, the whole of layers was taken out of the sputtering apparatus.

Upon completion of the film-forming, a coating solution for resin protective layers comprising an ultraviolet-curing acrylic resin was applied on the reflective layer by using a spinner so that the thickness thereof is within the range of 5 μm to 10 μm to form a resin protective layer by irradiating ultraviolet rays to harden the coating solution. Next, a substrate for adhesion made from a polycarbonate resin having a diameter of 12 cm and a thickness of 0.6 mm, which are same as those of the substrate 1, was laminated to the resin protective layer using an adhesion sheet, and the recording layer was crystallized in the initial stages by irradiating large-diameter LD beam. An optical recording medium for Example 1 was prepared by the above-mentioned procedure.

The crystallization temperature of the recording layer in the optical recording medium according to Example 1 with a temperature rising rate of 10° C./min. was 167° C.

<Evaluation>

With respect to the obtained optical recording medium, the measurement of the reflectance (Rg) of non-recorded portion in the recording layer relative to the laser beam wavelength of 650 nm to 665 nm showed 20% through the use of an optical disc evaluation apparatus (DDU-1000, manufactured by Pulstec Industrial Co., Ltd.).

Next, by using a recording system providing writable laser beam wavelength of 650 nm to 665 nm and lens NA 0.65 (optical disc evaluation apparatus (DDU-1000, manufactured by Pulstec Industrial Co., Ltd.)) to perform recording so as to have an equivalent recording density to that of DVD, the range of recordable linear velocity had a wide range of 3.5 m/s to 57 m/s.

Here, the evaluation of whether recordable or not was judged if the condition that the modulation degree (M) between the reflectance (Rg) of non-recorded portion and the reflectance of a recorded mark (M=(Rg−Rb)/Rg) being 0.4 or more is satisfied.

### EXAMPLE 2

Preparation of an Optical Recording Medium

An optical recording medium for Example 2 was prepared in the same manner as Example 1 except that the composition ratio of the recording layer was changed to Zn_{0.15}Sn_{0.44}Sb_{0.41}. The crystallization temperature on the recording layer of the optical recording medium for Example 2 with a temperature rising rate at 10° C./min. was 210° C.

With respect to the obtained optical recording medium, likewise Example 1, the measurement of the reflectance (Rg) in non-recorded portion of the recording layer relative to the laser beam wavelength of 650 nm to 665 nm showed 24%.

Also, recording was performed by using the same recording system as in Example 1, and the range of recordable linear velocity had a wide range of 3.5 m/s to 57 m/s, as in Example 1.

### EXAMPLE 3

Preparation of an Optical Recording Medium

An optical recording medium for Example 3 was prepared in the same manner as Example 1 except that the composition ratio of the recording layer was changed to Zn_{0.16}Sn_{0.29}Sb_{0.55}. The crystallization temperature on the recording layer of the optical recording medium for Example 3 with a temperature rising rate at 10° C./min. was 220° C.

With respect to the obtained optical recording medium, likewise Example 1, the measurement of the reflectance (Rg) in non-recorded portion of the recording layer relative to the laser beam wavelength of 650 nm to 665 nm showed 18%.

Also, recording was performed by using the same recording system as in Example 1, and the range of recordable linear velocity had a wide range of 3.5 m/s to 57 m/s, as in Example 1.

### EXAMPLE 4

Preparation of an Optical Recording Medium

An optical recording medium for Example 4 was prepared in the same manner as Example 1 except that the composition ratio of the recording layer was changed to Zn_{0.25}Sn_{0.47}Sb_{0.28}. The crystallization temperature on the recording layer of the optical recording medium for Example 4 with a temperature rising rate at 10° C./min. was 165° C.

With respect to the obtained optical recording medium, likewise Example 1, the measurement of the reflectance (Rg) in non-recorded portion of the recording layer relative to the laser beam wavelength of 650 nm to 665 nm showed 19%.

Also, recording was performed by using the same recording system as in Example 1, and the range of recordable linear velocity had a wide range of 3.5 m/s to 57 m/s, as in Example 1.

### EXAMPLE 5

Preparation of an Optical Recording Medium

An optical recording medium for Example 5 was prepared in the same manner as Example 1 except that the thickness of the recording layer was changed to 20 nm. The crystallization temperature on the recording layer of the optical recording medium for Example 5 with a temperature rising rate at 10° C./min. was 167° C.

With respect to the obtained optical recording medium, likewise Example 1, the measurement of the reflectance (Rg) of non-recorded portion of the recording layer relative to the laser beam wavelength of 650 nm to 665 nm showed 22%.

Also, recording was performed by using the same recording system as in Example 1, and the range of recordable linear velocity had a wide range of 3.5 m/s to 57 m/s, as in Example 1.

### EXAMPLE 6

Preparation of an Optical Recording Medium

An optical recording medium for Example 6 was prepared in the same manner as Example 1 except that the composition ratio of the recording layer was changed to Zn_{0.08}Sn_{0.14}Sb_{0.73}Te_{0.05}. The crystallization temperature on the recording layer of the optical recording medium for Example 6 with a temperature rising rate at 10° C./min. was 185° C.

With respect to the obtained optical recording medium, likewise Example 1, the measurement of the reflectance (Rg) in non-recorded portion of the recording layer relative to the laser beam wavelength of 650 nm to 665 nm showed 18%.

Also, recording was performed by using the same recording system as in Example 1, and the range of recordable linear velocity had a wide range of 3.5 m/s to 57 m/s, as in Example 1.

### COMPARATIVE EXAMPLE 1

Preparation of an Optical Recording Medium

An optical recording medium for Comparative Example 1 was prepared in the same manner as Example 1 except that the thickness of the first protective layer was changed to 120 nm. The crystallization temperature on the recording layer of the optical recording medium for Comparative Example 1 with a temperature rising rate at 10° C./min. was 167° C.

With respect to the obtained optical recording medium for Comparative Example 1, the measurement of the reflectance (Rg) in non-recorded portion of the recording layer relative to the laser beam wavelength of 650 nm to 665 nm showed 32% at the average and exceeded 30%.

Next, recording was performed using the same recording system as in Example 1, which has laser beam wavelength of 650 nm to 665 nm and lens NA 0.65, so that the medium have a recording density equivalent to that of DVD. As a result, the degree of modulation (M) (M=(Rg−Rb)/Rg) was less than 0.4. This can be considered that sufficient transformation-to-amorphous was not carried out due to the lowered absorption rate caused by the reflectance exceeding 30%. This is presumably caused by the fact that when the laser beam wavelength λ was from 650 nm to 665 nm and the thickness of the first protective layer was 120 nm, t₁/λ was about as much as 0.18 and exceeded 0.16.

### COMPARATIVE EXAMPLE 2

Preparation of an Optical Recording Medium

An optical recording medium for Comparative Example 2 was prepared in the same manner as Example 1 except that the thickness of the recording layer was changed to 30 nm. The crystallization temperature on the recording layer of the optical recording medium for Comparative Example 2 with a temperature rising rate at 10° C./min. was 167° C.

With respect to the obtained optical recording medium for Comparative Example 2, likewise Example 1, the measurement of the reflectance (Rg) of non-recorded portion in the recording layer relative to the laser beam wavelength of 650 nm to 665 nm showed 32% at the average and exceeded 30%.

Recording was performed using the same recording system as in Example 1, which has laser beam wavelength of 650 nm to 665 nm and lens NA 0.65, so that the medium have a recording density equivalent to that of DVD. As a result, the degree of modulation (M) (M=(Rg−Rb)/Rg) was less than 0.4. This can be considered that sufficient transformation-to-amorphous was not carried out due to the lowered absorption rate caused by the reflectance exceeding 30%. It can be considered that this was caused by the fact that when the laser beam wavelength λ was from 650 nm to 665 nm and the thickness of the recording layer t₂ was 30 nm, t₂/λ was equal to 0.045 and exceeded 0.032.

### COMPARATIVE EXAMPLE 3

Preparation of an Optical Recording Medium

Based on Example 1, sputtering was carried out with a chip of Zn loaded on a SnSb alloy target of the predetermined composition when forming a recording layer for Comparative Example 3. However, it was difficult to obtain a recording layer having the desired composition, and it was impossible to form a recording layer having the same composition in stable condition. Also, the reflectance (Rg) of non-recorded portion in the recording layer relative to the laser beam wavelength of 650 nm to 665 nm was dropped out of the range of 12% to 30%.

### COMPARATIVE EXAMPLE 4

Preparation of an Optical Recording Medium

An optical recording medium for Comparative Example 4 was prepared in the same manner as Example 1 except that the thickness of the recording layer was changed to 4 nm. With respect to the obtained optical recording medium, the reflectance (Rg) in non-recorded portion of the recording layer relative to the laser beam wavelength of 650 nm to 665 nm was measured, and the reflectance result was less than 12%. In addition, when recording was performed so as to have a recording density equivalent to that of DVD through the use of a recording system with the laser beam-writing wavelength being 650 nm to 665 nm and the optical lens NA being 0.65, a problem that sufficient signal strength cannot be obtained in the recording system occurred. It is considered that the problem was caused due to the fact that the reflectance was less than 12%. It is considered because when the laser beam wavelength of λ being 650 nm to 665 nm and the thickness of the recording layer of t₂ being 6 nm, the value of t2/λ becomes approx. 0.14 which does not satisfy the film thickness conditions.

The phase-change optical recording medium according to the present invention can respond to a wide range of recording speeds 1× to 16× or more those of DVD, for example, the medium is suitable for CD-R (CD-recordable), CD-RW, DVD+RW, DVD-RW, and DVD-RAM and can be widely used for recording media for large-capacity moving pictures, external storage media for personal computers, and the like.

1. An optical recording medium comprising:
a substrate, and at least a recording layer and a reflective layer disposed on the substrate,
wherein at least any one of recording, reproducing, erasing, and rewriting of information are enabled on the recording layer by inducing a reversible phase change on the recording layer by irradiating laser beam to the recording layer,
wherein the reflectance (Rg) of non-recorded portion of the recording layer in the case of the recording layer comprising Zn, Sn, and Sb and the wavelength of the laser beam being within the range of 650 nm to 665 nm is 12% to 30%.

2. The optical recording medium according to claim 1,
wherein the modulation degree (M) between the reflectance of a record mark in the recording layer (Rb) and the reflectance of non-recorded portion (Rg) (M=(Rg−Rb)/Rg) is 0.4 or more in the case of the wavelength of the laser beam being within the range of 650 nm to 665 nm, optical lens NA being 0.65 and the range of recording linear velocity (V) being 3.5 m/s<V≦57 m/s.

3. The optical recording medium according to claim 1,
wherein the composition of the recording layer is expressed by Zn_{α}Sn_{β}Sb_{γ}—X_{ε} (α, β, γ, and ε respectively represent an atomic ratio, and X represents at least one element selected from Mg, Al, Si, Ca, Cr, Mn, Co, Cu, Ga, Ge, Se, Te, Pd, Ag, and rare-earth elements), and expressed as follows:
0.03≦α≦0.3, 0.1≦β≦0.9, 0.1≦γ≦0.9, 0≦ε≦0.15, and α+β+γ+ε=1

4. The optical recording medium according to claim 1,
wherein the crystallization temperature on the recording layer with a temperature rising rate at 10° C./min. is 150° C. to 250° C.

5. The optical recording medium according to claim 1,
wherein the recording layer is formed by sputtering by using a sputtering target comprising Zn, Sn, and Sb.

6. The optical recording medium according to claim 5,
wherein the composition of the sputtering target is expressed by Zn_{α}Sn_{β}Sb_{γ}—X_{ε} (α, β, γ, and ε respectively represent an atomic ratio, and X represents at least one element selected from Mg, Al, Si, Ca, Cr, Mn, Co, Cu, Ga, Ge, Se, Te, Pd, Ag, and rare-earth elements), and expressed as follows:
0.03≦α≦0.3, 0.1≦β≦0.9, 0.1≦γ≦0.9, 0≦ε≦0.15, and α+β+γ+ε=1

7. The optical recording medium according to claim 1,
wherein the thickness of the recording layer is 5 nm to 20 nm.

8. The optical recording medium according to claim 1,
wherein a first protective layer, the recording layer, a second protective layer, and a reflective layer are disposed on the substrate in one of this sequence and the opposite sequence.

9. The optical recording medium according to claim 8,
wherein when the thickness of the first protective layer being t₁ (nm), the thickness of the recording layer being t₂ (nm), the thickness of the second protective layer being t₃ (nm), the thickness of the reflective layer being t₄ (nm), and the wavelength of the laser beam being λ (nm), the relations of the following formulas are satisfied:
0.070≦t₁/≦0.16, 0.015≦t₂/λ≦0.032, 0.009≦t₃/λ≦0.040, and 0.10≦t₄/λ

10. The optical recording medium according to claim 9, wherein the thickness of the first protective layer is 50 nm to 90 nm.

11. The optical recording medium according to claim 1,
wherein the reflective layer comprises any one of Ag and an Ag alloy.

12. The optical recording medium according to claim 1,
wherein the thickness of the reflective layer is 60 nm or more.

13. The optical recording medium according to claim 8,
wherein the second protective layer comprises a mixture of ZnS and SiO₂.

14. The optical recording medium according to claim 9, wherein the thickness of the second protective layer is 6 nm to 20 nm.

15. The optical recording medium according to claim 1,
wherein a third protective layer is disposed between the second protective layer and the reflective layer, and the third protective layer contains any one of SiC and Si but contains no sulfur therein.

16. The optical recording medium according to claim 15,
wherein the thickness of the third protective layer is 2 nm to 20 nm.

17. A method for recording and reproducing using an optical recording medium comprising:
irradiating laser beam from a first protective layer to the recording layer in an optical recording medium to perform at least any one of recording and reproducing of information,
the optical recording medium comprising:
a substrate, and at least a recording layer and a reflective layer on the substrate,
wherein at least any one of recording, reproducing, erasing, and rewriting of information are enabled on the recording layer by inducing a reversible phase change on the recording layer by irradiating laser beam to the recording layer,
wherein the reflectance (Rg) of non-recorded portion of the recording layer in the case of the recording layer comprising Zn, Sn, and Sb and the wavelength of the laser beam being within the range of 650 nm to 665 nm is 12% to 30%.

18. An apparatus for the optical recording and reproducing comprising:
an optical recording medium in which information is recorded and reproduced; and
laser beam source from which laser beam is irradiated to the optical recording medium for performing the optical recording and reproducing,
wherein the optical recording medium is an optical recording medium comprising:
a substrate, and at least a recording layer and a reflective layer disposed on the substrate;
wherein at least any one of recording, reproducing, erasing, and rewriting of information are performed by inducing a reversible phase change on the recording layer by irradiating laser beam to the recording layer; and the reflectance (Rg) of non-recorded portion in the recording layer in the case of the recording layer comprising Zn, Sn, and Sb and the wavelength of the laser beam being within the range of 650 nm to 665 nm is 12% to 30%.
